(19) United States
(12) Patent Application Publication
(10) Pub. No.: US 2024/0183960 A1
(43) Pub. Date: Jun. 6, 2024

(54) METHOD AND SYSTEM FOR DETECTING RELIABILITY OF LIDAR TRACK

(71) Applicants: Hyundai Motor Company, Seoul (KR); Kia Corporation, Seoul (KR)

(72) Inventors: Yoon Suk JANG, Seoul (KR); Hyun Ju Kim, Yongin-Si (KR)

(73) Assignees: Hyundai Motor Company, Seoul (KR); Kia Corporation, Seoul (KR)

(21) Appl. No.: 18/529,166

(22) Filed: Dec. 5, 2023

(30) Foreign Application Priority Data
Dec. 5, 2022 (KR) 10-2022-0167613

(51) Int. Cl. G01S 7/497; G01S 17/66

(52) U.S. Cl. CPC G01S 7/497; G01S 17/66

(57) ABSTRACT

A method for determining reliability of a LiDAR track includes determining reliability of tracking input information for tracking a target object represented by the LiDAR track based on the reliability of each predetermined features related to the LiDAR track; determining reliability of function processing of a system based on processing reliability of each of predetermined functions of the system for tracking the target object; and determining reliability of the LiDAR track based on the reliability of the tracking input information and the reliability of the function processing and output reliability information.

### CROSS-REFERENCE TO RELATED APPLICATION

The present application claims priority to Korean Patent Application No. 10-2022-0167613, filed on Dec. 5, 2022, the entire contents of which is incorporated herein for all purposes by this reference.

### BACKGROUND OF THE PRESENT DISCLOSURE

### Field of the Present Disclosure

The present disclosure relates to a method and system for determining the reliability of a LIDAR track.

### DESCRIPTION OF RELATED ART

Points obtained through the LiDAR of the vehicle may be frequently contaminated and covered due to the nature of the LiDAR. In the instant case, the LiDAR cannot provide accurate point data on the object required by the object detection system of the vehicle to the object detection system.

A conventional object detection system may generate and output a Light Detection and Ranging (LiDAR) track of an object including low reliability through inaccurate point data. The LiDAR track including low reliability may be used as data for driving control of the vehicle and may cause an error in the driving control of the vehicle.

Accordingly, in recent years, there is a need to develop a technology for determining the reliability of the LiDAR track.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method and system for determining reliability of a Light Detection and Ranging (LiDAR) track by determining and providing reliability of the LiDAR track for each object.

According to various exemplary embodiments of the present disclosure, a method for determining reliability of a LiDAR track includes determining reliability of tracking input information for tracking a target object of the LiDAR track based on reliability of each predetermined features related to the LiDAR track; determining reliability of function processing of a system based on processing reliability of each of predetermined functions of the system for tracking the target object; and determining reliability of the LiDAR track based on the reliability of the tracking input information and the reliability of the function processing and output reliability information.

The reliability of the tracking input information may be applied with a predetermined weight corresponding to at least one error information when receiving at least one of online misalignment estimation error information and blockage error information from the sensor device.

The determining of the reliability of the LiDAR track may include determining a first weight of the reliability of the tracking input information and a second weight of the reliability of the function processing based on a predetermined GaN weight corresponding to each range of reference tracking input information reliability and each range of reference function processing reliability, and determining the reliability of the LiDAR track by summing the reliability of the tracking input information to which the first weight is applied and the reliability of the function processing to which the second weight is applied.

The reliability of the LIDAR track may be applied with a predetermined weight corresponding to the LiDAR error information when the LiDAR error information is received from a LiDAR.

The predetermined features may include at least one of the number of points of the LiDAR track, location information of the LiDAR track, a number of contours generated based on the points, shape information of the LiDAR track, occlusion information of the LIDAR track, or viewing angle information of the LiDAR track.

The reliability of each of the predetermined features related to the LiDAR track may include a reliability score corresponding to the number of points based on predetermined score information corresponding to each of the number of reference points.

The position information may include first position information including a minimum X-axis coordinate value and a minimum Y-axis coordinate value of the LiDAR track and second position information including a minimum Z-axis coordinate value of the LIDAR track, and the reliability of each of the predetermined features related to the LIDAR track may include reliability scores corresponding to the minimum X-axis coordinate value and the minimum Y-axis coordinate value of the LIDAR track based on a predetermined score corresponding to each of the reference X-axis coordinate information and the reference Y-axis coordinate information and a reliability score corresponding to the minimum Z-axis coordinate value of the LiDAR track based on a predetermined score corresponding to the reference Z-axis coordinate information.

The reliability of each of the predetermined features related to the LiDAR track may include the reliability score corresponding to the number of contours generated based on the points, based on a predetermined score corresponding to each reference number of contours.

The reliability of each of the predetermined features related to the LiDAR track may include a reliability score corresponding to shape information of the LiDAR track based on a predetermined score corresponding to each L shape or shape other than the L shape.

The reliability of each of the predetermined features related to the LiDAR track may include the reliability score corresponding to the occlusion information of the LiDAR track and the viewing angle information of the LiDAR track, based on a predetermined score corresponding to whether the LiDAR track is located in a reference viewing angle range or not and a predetermined score corresponding to whether an occlusion occurs or not.

The predetermined functions may include at least one of a speed extraction function of the LiDAR track, a heading calculation function of the LiDAR track, a classification function of the LiDAR track, a function of determining whether the target object is a stationary object or a moving object, and a capability information generation function of the LIDAR track, and the processing reliability of each of the predetermined functions may include a reliability score within a predetermined reliability score range corresponding to each of the predetermined functions.

A system for determining reliability of a LiDAR track according to an exemplary embodiment of the present disclosure comprises an interface configured to receive sensor data from a sensor device and a processor configured to communicatively or electrically connected to the interface, wherein the processor is configured to determine reliability of tracking input information for tracking a target object represented by a LIDAR track based on reliability of each of unspecified features related to the LiDAR track generated based on points obtained from the LiDAR among the sensing devices, determine reliability of function processing of the system based on processing reliability of each of predetermined functions of the system for tracking the target object, and determine reliability of the LiDAR track based on the reliability of the tracking input information and the reliability of the function processing, to output reliability information.

The reliability of the tracking input information may be obtained by applying a predetermined weight corresponding to at least one error information when receiving at least one of online misalignment estimation error information and blockage error information from the sensing device.

The processor may be further configured to determine a first weight of the reliability of the tracking input information and a second weight of the reliability of the function processing based on the predetermined weight corresponding to each range of the reference tracking input information reliability and each range of the reference functional processing reliability, and determine the reliability of the LiDAR track by summing the reliability of the tracking input information to which the first weight is applied and the reliability of the function processing to which the second weight is applied.

The reliability of the LiDAR track may be applied with a predetermined weight corresponding to the LiDAR error information when the LiDAR error information is received from a LIDAR.

The predetermined features may include at least one of the number of points of the LiDAR track, position information of the LiDAR track, a number of contours generated based on the points, shape information of the LiDAR track, occlusion information of the LIDAR track, or viewing angle information of the LiDAR track.

The reliability of each of the predetermined features related to the LiDAR track may include a reliability score corresponding to the number of points based on predetermined score information corresponding to each of the number of reference points.

The position information may include first position information including a minimum X-axis coordinate value and a minimum Y-axis coordinate value of the LiDAR track and second position information including a minimum Z-axis coordinate value of the LiDAR track, and the reliability of each of the predetermined features related to the LIDAR track may include reliability scores corresponding to the minimum X-axis coordinate value and the minimum Y-axis coordinate value of the LIDAR track based on the predetermined score corresponding to each of the reference X-axis coordinate information and the reference Y-axis coordinate information and the reliability score corresponding to the minimum Z-axis coordinate value of the LiDAR track based on a predetermined score corresponding to the reference Z-axis coordinate information.

The reliability of each of the predetermined features related to the LiDAR track includes at least one reliability score of a reliability score corresponding to the number of contours generated based on the points based on a predetermined score corresponding to each reference number of contours, a reliability score corresponding to the shape information of the LiDAR track based on a predetermined score corresponding to each L shape or shape other than the L shape, or a reliability score corresponding to the viewing angle information and the occlusion information of the LiDAR track based on a predetermined score corresponding to whether the LiDAR track is located in a reference viewing angle range or not and a predetermined score corresponding to whether an occlusion occurs or not.

The predetermined functions may include at least one of ta speed extraction function of the LiDAR track, a heading calculation function of the LiDAR track, a classification function of the LiDAR track, a function of determining whether the target object is a stationary object or a moving object, and a capability information generation function of the LiDAR track, and the processing reliability of each of the predetermined functions may include a reliability score within the predetermined reliability score range corresponding to each of the predetermined functions.

The method and system for determining reliability of the LIDAR track according to an exemplary embodiment of the present disclosure may determine and provide reliability of the LiDAR track for each object.

Accordingly, the object detection system receiving the reliability information of the LiDAR track for each object determined according to the exemplary embodiment of the present disclosure may identify information of the LiDAR track on which the moving object including the high reliability is selected, and may maintain the LiDAR track of the moving object.

Furthermore, the object detection system receiving the reliability information of the LiDAR track for each object determined according to the exemplary embodiment of the present disclosure may identify information indicating that the LIDAR track of the gas, such as exhaust gas, has low reliability, controlling the LiDAR track indicating the gas. It may not be used for words.

Furthermore, the object detection system receiving the reliability information of the LiDAR track for each object determined according to the exemplary embodiment of the present disclosure may identify information indicating that the LiDAR track of the ground which may be recognized as the object has low reliability, and thus may not use the LiDAR track indicating the ground for control.

Furthermore, the object detection system receiving the reliability information of the LiDAR track for each object determined according to the exemplary embodiment of the present disclosure may identify information indicating that the LiDAR track indicating the object of which the shape is rapidly changed has low reliability, and thus may not use the LiDAR track indicating the object of which the shape is rapidly changed for control.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block drawing of a vehicle according to an exemplary embodiment of the present disclosure.

FIG. 2 is a flowchart of an operation of a system for determining reliability of a LIDAR track according to an exemplary embodiment of the present disclosure.

FIG. 3 is a flowchart of an operation of a system for determining reliability for determining reliability of tracking input information according to the exemplary embodiment of FIG. 2.

FIG. 4 is a flowchart of an operation of a system for determining reliability for reliability determination of tracking function processing according to the exemplary embodiment of FIG. 2.

FIG. 5 is a drawing for explaining application of a weight when determining reliability of a LiDAR track according to an exemplary embodiment of the present disclosure.

FIG. 6 is a flowchart of an operation of a system for determining reliability according to an exemplary embodiment of the present disclosure.

FIG. 7A, FIG. 7B and FIG. 7C, FIG. 8A, FIG. 8B and FIG. 8C, FIG. 9A, FIG. 9B and FIG. 9C and FIG. 10A, FIG. 10B and FIG. 10C are diagrams for explaining an effect of an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Like reference numerals refer to like elements throughout the specification. The present specification does not describe all elements of the embodiments, and general contents in the field of the present disclosure to which an exemplary embodiment of the present disclosure pertains or overlapping contents between the exemplary embodiments are omitted. The term “unit, module, or device” used in the specification may be implemented by software or hardware, and according to various exemplary embodiments of the present disclosure, a plurality of “units, modules, or devices” may be implemented as one element or one “unit, module, or device” may include a plurality of elements.

Throughout the specification, when a part is “connected” to another part, it includes the case of being directly connected and the case of being indirectly connected, and the indirect connection includes being connected through a wireless communication network.

Furthermore, when a part “includes” an element, this means that other elements may be further included rather than excluding other elements unless specifically stated otherwise.

The terms “first”, “second”, etc. are used to distinguish one element from another element, and the element is not limited by the above terms.

A singular expression includes a plural expression unless there is a clear exception in the context.

In each step, an identification symbol is used for convenience of description, and thus the identification symbol does not describe an order of each step, and each step may be performed in a different order from a specified order unless a specific order is clearly described in the context.

Hereinafter, operation principles and embodiments of the present disclosure will be described with reference to the accompanying drawings.

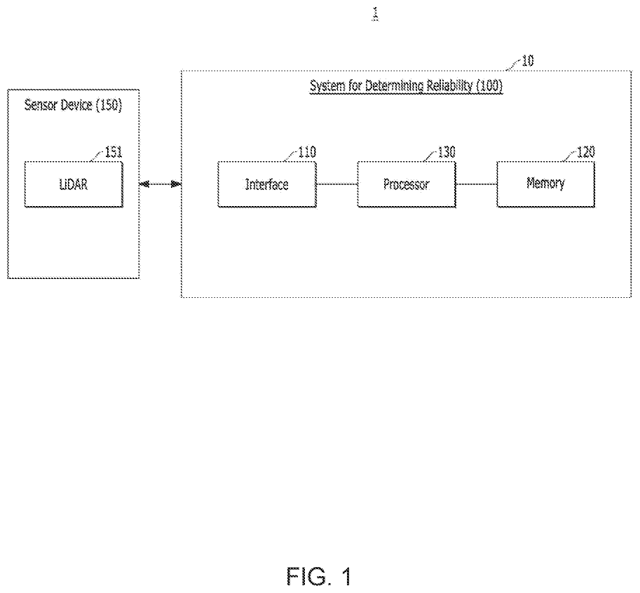

FIG. 1 is a block drawing of a vehicle according to an exemplary embodiment of the present disclosure.

Referring to FIG. 1, a vehicle 1 may include an object detection system 10 and a sensing device 150, and the object detection system 10 may include a system 100 determining reliability of a LIDAR track.

The system for determining reliability 100 may include an interface 110, a memory 120, and/or a processor 130.

The interface 110 may transfer an instruction or data input from another device (i.e., the sensing device 150 and/or the vehicle control device) of the vehicle 1 or a user to another feature element of the system for determining reliability 100, or may output an instruction or data received from another feature element of the system for determining reliability 100 to another device of the vehicle 1.

The interface 110 may include a communication module to communicate with other devices of the vehicle 1.

For example, the communication module may include a communication module configured for performing communication between devices of the vehicle 1, for example, Controller Area Network (CAN) communication and/or Local Interconnect Network (LIN) communication, through a vehicle communication network. Furthermore, the communication module may include a wired communication module (i.e., a power line communication module) and/or a wireless communication module (i.e., a cellular communication module, a Wi-Fi communication module, a short-range wireless communication module, and/or a global navigation satellite system (GNSS) communication module).

The memory 120 may store various data used by at least one feature element of the system for determining reliability 100. e.g., input data and/or output data for a software program and commands related thereto.

The memory 120 may include a nonvolatile memory such as a cache, a Read Only Memory (ROM), a Programmable ROM (PROM), an Erasable Programmable ROM (EPROM), an Electrically Erasable Programmable ROM (EEPROM), and/or a flash memory, and/or a volatile memory such as a Random Access Memory (RAM).

The processor 130 (also referred to as a control circuit or a controller) may be configured for controlling at least one other feature element (i.e., a hardware feature element (i.e., the interface 110 and/or the memory 120) and/or a software feature element (a software program)) of the system for determining reliability 100 and may perform various data processing and operations.

The processor 130 may be configured to determine the reliability of the tracking input information for tracking the target object represented by the LiDAR track based on the reliability of each of the predetermined features related to the LiDAR track.

The processor 130, when receiving the online misalignment estimation error information and/or the blockage error information from the sensor device 150, may apply (or reflect) a predetermined weight corresponding to the received error information to the reliability of the determined tracking input information.

The processor 130 may be configured to determine the function processing reliability of the corresponding system based on the processing reliability of each of the predetermined functions of the system for tracking the target object (also referred to as the object detection system 10).

The processor 130 may be configured to determine the reliability of the LiDAR track based on the reliability of the tracking input information and the reliability of the function processing to output reliability information.

The processor 130 may be configured to determine a first weight of the reliability of the tracking input information and a second weight of the reliability of the function processing based on the range of the reliability of each reference tracking input information stored in the memory 120 and information of a predetermined weight corresponding to the range of the reliability of the reference function processing. For example, the sum of the first weight and the second weight may be 1.

The processor 130 sums the reliability of the tracking input information to which the first weight value is applied and the reliability of the function processing to which the second weight value is applied to determine the reliability of the LIDAR track

Upon receiving LiDAR error information (also referred to as LiDAR H/W Failsafe) from the LiDAR 151, the processor 130 may apply (also referred to as reflection) a predetermined weight corresponding to the LiDAR error information to the determined reliability of the LiDAR track, and finally determine the reliability of the LIDAR track.

The sensing device 150 may include one or more devices configured for obtaining information related to an object (also referred to as a target) located around the vehicle 1.

The sensing device 150 may include a Light Detection and Ranging (LiDAR) 151.

The LIDAR 151 may be one or a plurality (i.e., a left LiDAR and/or a right LiDAR), and may be mounted in the vehicle 1 to emit a laser pulse toward the periphery of the vehicle 1 to generate LiDAR data, that is, a plurality of point data (also referred to as point cloud data).

Meanwhile, although not shown, the sensor device 150 may further include a radio detection and ranging (RADAR) configured for detecting objects around the vehicle 1 and/or a camera configured for obtaining image data around the vehicle 1.

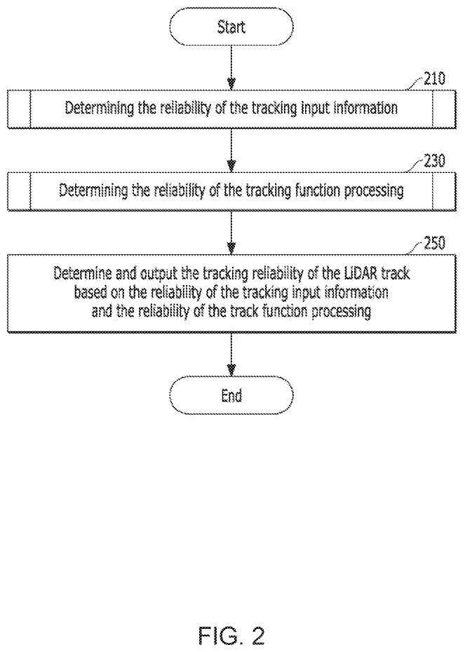

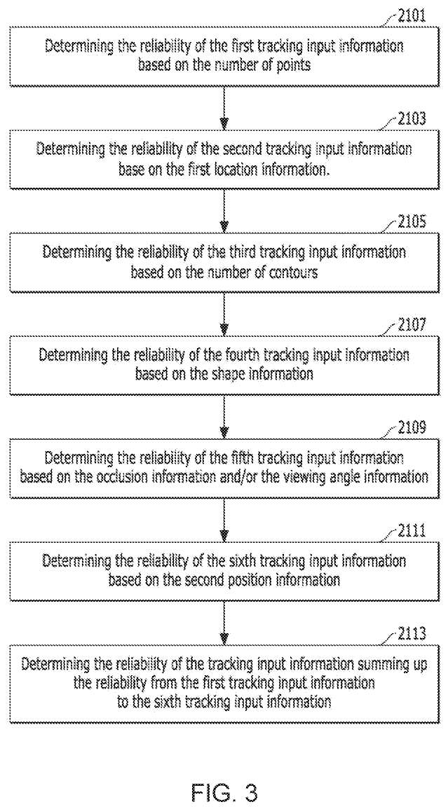

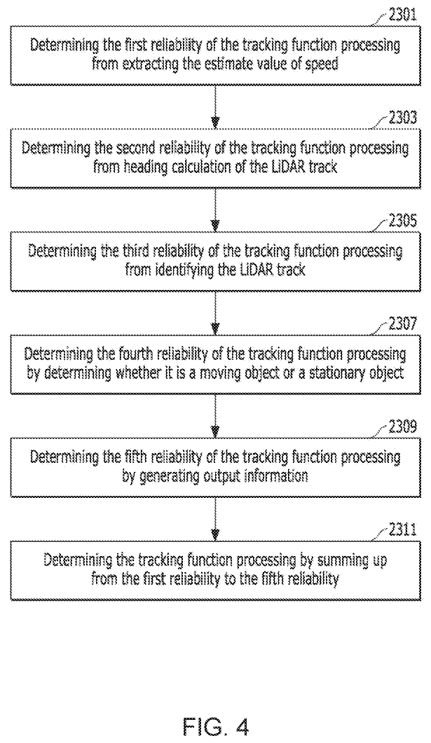

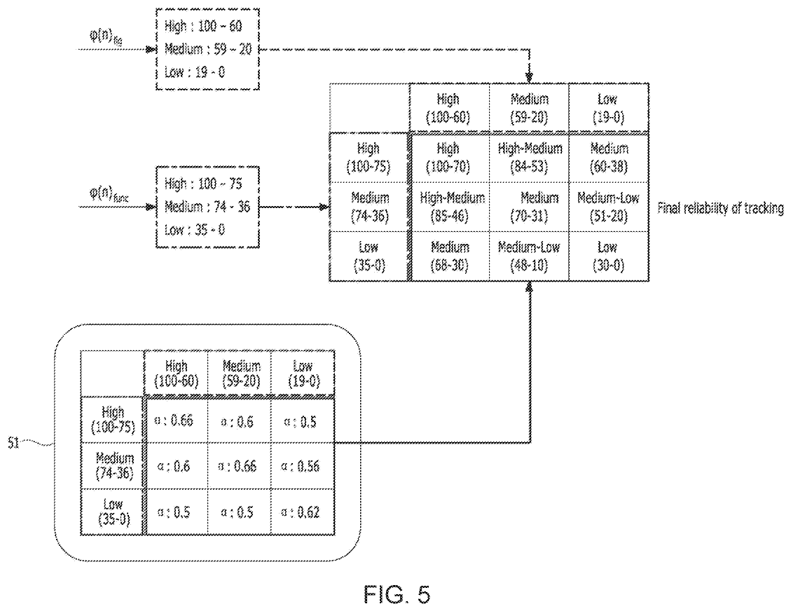

FIG. 2 is a flowchart of an operation of the system 100 (and/or the processor 130) for determining reliability of a LiDAR track according to an exemplary embodiment of the present disclosure. FIG. 3 is a flowchart of the operation of the system for determining reliability 100 (and/or the processor 130) for determining the reliability of tracking input information according to the exemplary embodiment of FIG. 2. FIG. 4 is a flowchart of the operation of the system (and/or processor 130) for determining reliability of tracking function processing according to the exemplary embodiment of FIG. 2. FIG. 5 is a diagram for describing application of a weight when reliability of a LiDAR track is determined according to an exemplary embodiment of the present disclosure.

Referring to FIG. 2, the system for determining reliability 100 relates to a Light Detection and Ranging (LIDAR) based on the reliability of each of the predetermined features, the reliability of the tracking input information (φ(n)_{fig}) may be determined (210).

The LiDAR track may be generated by applying at least one of the conventional LIDAR track generation techniques based on points obtained from the LiDAR 151.

The predetermined features related to the LiDAR track may include the number of points of the LiDAR track, position information of the LiDAR track, a number of contours generated based on the points, shape information of the LiDAR track, occlusion information of the LiDAR track, and/or viewing angle information of the LiDAR track.

For example, the system 100 for determining reliability may perform operations as illustrated in FIG. 3, to determine the reliability of tracking input information (φ(n)_{fig})

Referring to FIG. 3, the system 100 for determining reliability may be configured to determine a the reliability of the first tracking input information (φ(n)_{box(point number)}) based on the number of points of the LiDAR track (2101).

First information of the first tracking input information reliability corresponding to each condition related to the number of points of the LiDAR track may be predetermined as shown in Table 1, and the system 100 for determining reliability may be configured to determine the first tracking input information reliability based on the predetermined first information.

TABLE 1

| | First tracking input information |
|---|---|
| Conditions | reliability |
| Number of points > First reference | First score |
| number of points | |
| First reference number of points >= | Second score (<first score) |
| Number of points > | |
| Second reference number of points | |
| Second reference number of points >= | Third score (<second score) |
| Number of points > | |
| Third reference number of points | |
| Third reference number of points >= | Fourth score (<third score) |
| Number of points > | |
| Fourth reference number of points | |

The first to fourth reference numbers of points in Table 1 described above may be predetermined numbers. For example, the first reference number of points is 1000, the second reference number of points is 100, the third reference number of points is 50, and the fourth reference number of points is 10, and the reference numbers may be changed depending on a designer's intention.

In Table 1, the first to fourth scores may be predetermined scores, for example, the first score may be 30, the second score may be 20, the third score may be 10, and the fourth score may be 5.

Furthermore, when all of the conditions of Table 1 described above are not satisfied, the reliability of the first tracking input information may be 0 point.

The system 100 for determining reliability may be configured to determine the second reliability of tracking input information (φ(n)_{box(point number)}) based on the first position information of the LiDAR track (2103).

Second information of the second tracking input information reliability corresponding to each condition related to the first position information of the LiDAR track may be predetermined as shown in Table 2. The system 100 for determining reliability may be configured to determine the second tracking input information reliability based on predetermined second information.

The first position information may include a vertical axis coordinate value LongPos and/or a horizontal axis coordinate value LatPos.

TABLE 2

| | Second tracking input |
|---|---|
| Conditions | information reliability |
| Minimum vertical axis coordinate value | Fifth score |
| (Y-axis coordinate value) of a LiDAR | |
| track < First reference value | |
| Minimum horizontal coordinate value | Sixth score |
| (X-axis coordinate value) of a LiDAR | |
| track < Second reference value | |

The first reference value and the second reference value in Table 2 described above may be predetermined values. For example, each of the first reference value and the second reference value may be 5 m, and the first reference value and the second reference value may be changed depending on the designer's intention.

Furthermore, the fifth score and the sixth score in Table 2 described above may be predetermined scores, and for example, each of the fifth score and the sixth score may be 5 points.

When all of the conditions of Table 2 are satisfied, the second tracking input information reliability may be a result value obtained by summing the fifth score and the sixth score.

Furthermore, when all of the conditions of Table 2 described above are not satisfied, the reliability of the second tracking input information may be 0 point.

For example, in another expression of Table 2, when the minimum distance from the origin point of the vehicle coordinate system (i.e., the center portion of the front bumper of the vehicle 1) to the LiDAR track in the longitudinal direction is smaller than a predetermined first reference value, the second tracking input information reliability may be set to be the fifth score. Furthermore, when the minimum distance from the origin of the vehicle coordinate system to the LiDAR track in the horizontal direction is smaller than a predetermined second reference value, the second tracking input information reliability may be predetermined to be the sixth score.

The system 100 for determining reliability based on track points of the LiDAR is configured to determine the third tracking input information reliability (φ(n)_{box(contour)}) based on the information of the number of generated contours (2105).

Third information of third tracking input information reliability corresponding to each condition related to the number of contours may be predetermined as shown in Table 3. The system 100 for determining reliability may be configured to determine the third tracking input information reliability based on the predetermined third information.

TABLE 3

| | Third reliability of tracking input |
|---|---|
| Conditions | information |
| Number of contours > first reference | Seventh score |
| number of contours | |
| Number of contours > second reference | Eighth score (>eighth score) |
| number of contours | |

In Table 3, the first reference number of contours may be a predetermined number, and the first reference number of contours may be greater than the second reference number of contours. For example, the first reference number of contours may be 4, and the second reference number of contours may be 2. The reference number of contours may be changed depending on the designer's intention.

In Table 3, the seventh score and the eighth score may be predetermined scores, and for example, the seventh score may be 10 points and the eighth score may be 5 points.

Furthermore, if all of the conditions of Table 3 described above are not satisfied, the third tracking input information reliability may be 0 point.

The system 100 for determining reliability may be configured to determine the fourth tracking input information reliability (φ(n)_{box(L-Shape)}) based on the shape information of the LiDAR track (2107).

The fourth information of the fourth tracking input information reliability may be determined corresponding to a condition related to shape information of the LiDAR track. The system 100 for determining reliability may be configured to determine the fourth tracking input information reliability based on the predetermined fourth information.

The shape information of the LiDAR track may include an L-shape and a shape other than the L-shape. Determining whether the LiDAR track is in L-shape may be performed with L-shaped identification techniques in conventional object recognition techniques.

When the LiDAR track has an “L” shape, the fourth tracking input information reliability may be predetermined to be a predetermined ninth score, and for example, the ninth score may be 20 points.

Furthermore, when the LiDAR track includes a shape other than the “L” shape, the fourth tracking input information reliability may be predetermined to be a predetermined tenth score, and for example, the tenth score may be 0.

The system for determining reliability 100 may be configured to determine a fifth tracking input information reliability based on occlusion information and/or viewing angle information of the LiDAR track (φ(n)_{box(Occlusion&FOV)}) may be determined (2109).

Fifth information of the fifth tracking input information reliability corresponding to each of occlusion information and/or viewing angle information of the LIDAR track may be predetermined. The system 100 for determining reliability may be configured to determine the fifth tracking input information reliability based on the predetermined fifth information.

The occlusion information of the LiDAR track may include information indicating that the LiDAR track has no portion occluded by other LiDAR track, and the 11^{th} score corresponding to the occlusion information may be predetermined.

Also, the occlusion information of the LiDAR track may include a portion of the LiDAR track which is at least partially occluded by at least one other LIDAR track, and the 12^{th} score corresponding to the occlusion information may be predetermined.

For example, the predetermined 11^{th} confidence score may be 30 points, and the predetermined 12^{th} score may be 0 points.

The viewing angle information of the LiDAR track may include information indicating that the LiDAR track is within a predetermined viewing angle range in the vehicle coordinate system, and the 13^{th} score corresponding to the LiDAR track may be predetermined.

The viewing angle information of the LiDAR track may include information indicating that the LIDAR track is not within the predetermined viewing angle range in the vehicle coordinate system, and the 14^{th} score corresponding to the information may be predetermined.

For example, the predetermined viewing angle range may include a range indicating left and right boundaries of 0 degrees and 180 degrees in the vehicle coordinate system, i.e., the first range including 0 degrees and the second range including 180 degrees.

For example, the predetermined 13^{th} score may be 20 points, and the predetermined 14^{th} score may be 0 points.

For example, when occlusion information of the LiDAR track that the LiDAR track has no portion occluded by another LIDAR track and viewing angle information of the LiDAR track that the LIDAR track is within the predetermined viewing angle range in the vehicle coordinate system are identified, the fifth tracking input information reliability may be a score obtained by summing the 11^{th} score and the 13^{th} score.

Furthermore, when the LiDAR track is not within the predetermined viewing angle range in the vehicle coordinate system and occlusion information of the LiDAR track indicating that the LiDAR track has no portion occluded by another LiDAR track is identified, the fifth tracking input information reliability may be the 11^{th} score.

Furthermore, when it is identified that at least a portion of the LiDAR track is occluded by at least one other LiDAR track and the LiDAR track is within the predetermined viewing angle range in the vehicle coordinate system, the fifth tracking input information reliability may be the 13^{th} score.

The system 100 for determining reliability may be configured to determine the sixth tracking input information reliability (φ(n)_{box(minZpos)}) based on the second location information of the LiDAR track (2111).

The six information of the sixth tracking input information reliability corresponding to the second position information condition of the LiDAR track may be predetermined and the system 100 for determining reliability may be configured to determine the sixth tracking input information reliability based on the predetermined sixth information.

The second position information of the LiDAR track may include a minimal Z coordinate value (minZpos) of the LiDAR track.

When the minimal Z coordinate value of the LiDAR track is greater than a predetermined third reference value, the sixth tracking input information reliability may be predetermined to be the predetermined 15^{th} score. In other words, when the minimal separated distance of the LiDAR track from the ground is greater than the predetermined third reference value, the sixth tracking input information reliability may be predetermined to be the 15^{th} score.

Furthermore, when the minimal Z coordinate value of the LiDAR track is equal to or less than the predetermined third reference value, the sixth tracking input information reliability may be predetermined to be 0 point.

For example, the third reference value may be 1.2 m and may be changed depending on the designer's intention. Also, for example, the 15^{th} score may be −40.

The system 100 for determining reliability may be configured to determine the reliability of the tracking input information by summing the first, second, third, fourth, fifth and sixth tracking input information reliability (2113).

The reliability of the tracking input information may be the reliability score (also referred to as a reliability level) included in the range of 0 to 100.

The system 100 for determining reliability may be configured to determine the reliability (φ(n)_{func}) of processing of the tracking function based on the reliability of processing of each of predetermined functions of the system for tracking a target object indicated by the LiDAR track (230).

The predetermined functions may include a speed extraction function of the LiDAR track, a heading calculation function of the LiDAR track, a classification function of the LiDAR track, a function of determining whether a target object is a stationary object or a moving object chain, and/or a function of generating output information of the LiDAR track.

A reliability score range able to be set may be predetermined for each of the predetermined functions. For example, the reliability score range may be predetermined so that the speed extraction function of the LiDAR track is 0 to 15 points, the heading calculation function of the LIDAR track is 0 to 15 points, the classification function of the LIDAR track is 0 to 5 points, the function of determining whether the target object is a stationary object or a moving object is 0 to 60 points, and/or the output information generation function of the LiDAR track is 0 to 5 points.

For example, the system 100 for determining reliability may be configured to determine the reliability of the tracking function processing (φ(n)_{func}) through operations such as those of FIG. 4.

Referring to FIG. 4, the system 100 for determining reliability extracts a speed of a measured value A first reliability of the tracking function processing (φ(n)_{func(velocity)}) may be determined (2301).

The system for determining reliability 100 may be configured to determine the first reliability based on the tremor information of the LiDAR track, the position information of the LiDAR track, the speed information of the vehicle 1, and/or the occlusion information of the LiDAR track by another LiDAR track.

For example, the system 100 for determining reliability may increase the first counter (also referred to as Velocity Stable Counter) by 1 when there is no tremor of the LiDAR track, the LIDAR track is present within a road boundary, the speed of the vehicle 1 is not rapidly decelerated, and the LiDAR track is not covered by another LiDAR track.

The first counter may be increased by 1 whenever the above condition is satisfied at each time step during the maintaining time of the LiDAR track of the object until the current time step (T step).

When the first counter in the current time step T step is equal to or greater than the first reference counter value, the first tracking function processing reliability may be predetermined to be the 16^{th} score.

When the first counter in the current time step T step is smaller than the first reference counter value and greater than the second reference counter value, the first tracking function processing reliability may be previously predetermined to be the 17^{th} score.

When the first counter in the current time step T step is equal to or less than the second reference counter value, the first tracking function processing reliability may be predetermined to be the 18^{th} score.

Each of the first and second reference counter values may be a predetermined value and may be changed depending on the designer's intention.

The 16^{th} to 18^{th} scores may be predetermined to have the relationship of the 16^{th} score > the 17^{th} score > the 18^{th} score.

The system 100 for determining reliability may be configured to determine the second reliability of the heading calculation function processing (φ(n)_{func(heading)}) of the LIDAR track (2303).

Based on a difference in the heading of the LiDAR track between the current time T step and the previous time T-1 step, the system 100 for determining reliability may be configured to determine the third reliability.

For example, the system 100 for determining reliability may be configured to determine the state of the heading calculation function to be the first state (also referred to as a stable state) when the difference between the heading of the LiDAR track at the current time step T and the heading of the LiDAR track at the previous time step T-1 is less than a predetermined reference angle, and otherwise may be configured to determine the state of the heading calculation function to be the second state (also referred to as a transient state). For example, the predetermined reference angle may be 90 and may be changed depending on the designer's intention.

When the system 100 for determining reliability determines the state of the heading calculation function as the first state, the second counter (also referred to as a stable counter) may be increased by 1.

The second counter may be increased by 1 whenever the above condition is satisfied at each time step during the maintaining time of the LiDAR track of the object, until the current time step (T step).

When the second counter in the current time step T is equal to or greater than the third reference counter value, the third reliability may be predetermined to be the 19^{th} score.

Furthermore, when the second counter in the current time step T is less than the third reference counter value, the third reliability may be predetermined to be the 20^{th} score.

When the state of the heading calculation function is the second state, the third reliability may be predetermined to be the 21^{st} score.

The third reference counter value may be a predetermined value and may be changed depending on the designer's intention.

The 19^{th} score to the 21^{st} score may be previously designated to have the relationship of the 19^{th} score > the 20^{th} score > the 21^{st} score.

The system 100 for determining reliability may be configured to determine a third reliability (φ(n)_{func(class)}) of the classification function processing of the LIDAR track (2305).

The consistency ratio of the classification result of the object represented by the LiDAR track may include an output result of a convolutional neural network (CNN).

For example, the classification of the object represented by the LiDAR track may be performed through the CNN, may output the consistency ratio for specific classes, and the consistency ratio can be referred to as the accuracy ratio.

The system 100 for determining reliability may be predetermined so that the third reliability is the 22^{nd} score when the consistency ratio of the classification result of the object indicated by the LiDAR track is equal to or greater than the first reference consistency ratio.

The system 100 for determining reliability may be configured to determine the third reliability to be the 23^{rd} score when the consistency ratio of the classification result of the object represented by the LiDAR track is smaller than the first reference consistency ratio and is equal to or greater than the second reference consistency ratio.

When the consistency ratio of the classification result of the object represented by the LiDAR track is less than the second reference consistency ratio, the system 100 for determining reliability may predetermined the third reliability to be the 24^{th} score.

The system 100 for determining reliability may be configured to determine the third reliability to be the 24^{th} score when the difference between the size of the object determined according to the classification result and the actual measured size of the object is large, e.g., when the difference is equal to or greater than a predetermined reference size error range. For example, when the classification result is a pedestrian, and when the width of the object is 3 m or more, the third reliability score P may be the 24^{th} score.

The first and second reference consistency ratios may be predetermined so that the first consistency reference ratio is a value of a larger ratio than the second consistency ratio, and the value of each ratio may be changed depending on the designer's intention.

The 22^{nd} score, the 23^{rd} score, and the 24^{th} score are predetermined to include the relationship of 22^{nd} score >23^{rd} score>24^{th} score.

The system 100 for determining reliability whether the object is a moving object or a stationary object determines the fourth reliability (φ(n)_{func(moving)}) of the determining function processing (2307).

The system 100 for determining reliability 100 may assign a score according to a predetermined score table based on characteristics including a driving route, a speed, an age, road information, a classification, a degree of occlusion, and/or the number of points of an object, etc.

For example, the score table may be preset by determining the score corresponding to each of predetermined characteristics of the stationary object and the score corresponding to each of predetermined characteristics of the moving object.

The system 100 for determining reliability may predetermine the movement determination score and the stop determination score by adding a corresponding score for a characteristic that matches the characteristics of the object by comparing the characteristics of the object with each item of a preset score table.

When each score primarily assigned in the current step, e.g., the movement determination score and the stop determination score is lower than the reference score, the fourth reliability may be predetermined to be the 25^{th} score.

when the score provided first in the current step is equal to or greater than the reference score, then the third counter (or status counter) may be increased by 1.

The third counter may be increased by 1 whenever the condition is satisfied during the maintaining time of the LiDAR track of the object until the current time step T.

When the third counter is less than the fourth reference counter at the current step, the fourth reliability may be predetermined to be the 26^{th} score.

When the third counter is equal to or greater than the fourth reference counter at the current step, the fourth reliability may be predetermined to be the 274 score.

The fourth reference counter may be a predetermined value and may be changed depending on the designer's intention.

The 25^{th} score to the 27^{th} score may be predetermined to include the relationship of 25^{th} score <26^{th} score <27^{th} score.

The system 100 for determining reliability is configured to determine a fifth reliability (φ(n)_{func(output)}) of output information generation function processing (2309).

When the output information is a normal output, the fifth reliability may be previously designated to be the 29^{th} score.

When the output information is an abnormal output, the fifth reliability may be predetermined to be the 30^{th} score.

Whether the output information is normal output or abnormal output is determined by determining whether a transient state where the result value at the current time step and the result value up to a previous time step are different from each other and/or whether the history of a LiDAR track is different from a current LiDAR track.

For example, in the filtering process for generating the output information, when the location information of the object is different from the predetermined position information of the same object by a threshold value or more, or when the shape of the object is rapidly smaller or greater than the predetermined shape of the same object, it may be determined that the output is abnormal.

Each of the 29^{th} score and the 30^{th} score may be a predetermined score. e.g., the 29^{th} score > the 30^{th} score, e.g., the 30^{th} score may be 0.

The system 100 for determining reliability may be configured to determine the reliability of the tracking function processing by summing the first to fifth reliabilities (2311).

The reliability of the tracking function processing may be a reliability score (also referred to as a reliability level) included in a range of 0 to 100.

Referring back to FIG. 2, the system 100 for determining reliability may be configured to determine and output the tracking reliability of the LiDAR track based on the reliability of the tracking input information and the reliability of the tracking function processing (250).

The system 100 for determining reliability may variably apply the predetermined weighting parameter α to the reliability (φ(n)_{fig}) and the reliability of the tracking function processing (φ(n)_{func}) to determine the tracking reliability.

Referring to FIG. 5, each of the reliability of the tracking input information (φ(n)_{fig}) and the reliability of the tracking function processing (φ(n)_{func}) may be classified into high, middle, and low according to a reliability score.

For example, as shown in FIG. 5, a criterion may be predetermined so that when the reliability (φ(n)_{fig}) of the tracking input information is high when it is in 100 to 60, is medium when it is in 59 to 20, and is low when it is in 19 to 0.

Furthermore, as shown in FIG. 5, a criterion may be predetermined so that the reliability (φ(n)_{func}) of the tracking function processing is determined as “high” when it is in 100-70, as ‘medium’ when it is within 74 to 36, and as ‘low’ when it is within 35 to 0.

Also, as shown in FIG. 5, considering the reliability (φ(n)_{fig}) of the tracking input information and the reliability (φ(n)_{func}) of tracking function processing, the reliability of tracking may be predetermined to high, high-medium, medium, medium-low, or low.

Referring to the table 51 of FIG. 5, the weight parameter α may be predetermined based on the reliability (φ(n)_{fig}) of the tracking input information and the reliability (φ(n)_{func}) of the tracking function processing.

The system 100 for determining reliability 100 may be configured to determine the reliability score of the tracking reliability through Equation 1 below. Equation 1:

reliability score=αφ_{func}+(1−α)φ_{fig}

wherein α denotes a weight parameter (i.e., table 51 of FIG. 5), φ(n)_{fig} denotes reliability of tracking input information, and φ(n)_{func} denotes reliability of tracking function processing.

For example, when the reliability (φ(n)_{fig}) of the tracking input information and the reliability (φ(n)_{func}) of the tracking function processing are high, the final reliability of the tracking information may be high, and the corresponding score, according to table 51 of FIG. 5 and its Equation 1, may be 100 to 70.

If the reliability (φ(n)_{fig}) of the tracking input information is medium and the reliability (φ(n)_{func}) of the tracking function processing is high, the reliability of the tracking information may be high-medium, and the corresponding score, according to table 51 of FIG. 5 and the above-mentioned Equation 1, may be 84 to 53.

If the reliability (φ(n)_{fig}) of the tracking input information is low and the reliability (φ(n)_{func}) of the tracking function processing is high, the reliability of the tracking information may be medium, and the corresponding score, according to table 51 of FIG. 5 and the above-mentioned Equation 1, may be 60 to 38.

If the reliability (φ(n)_{fig}) of the tracking input information is high and the reliability (φ(n)_{func}) of the tracking function processing is medium, the reliability of the tracking information may be high-medium, and the corresponding score, according to table 51 of FIG. 5 and the above-mentioned Equation 1, may be 85 to 46.

If the reliability (φ(n)_{fig}) of the tracking input information is low and the reliability (φ(n)_{func}) of the tracking function processing is medium, the reliability of the tracking information may be medium, and the corresponding score, according to table 51 of FIG. 5 and the above-mentioned Equation 1, may be 70 to 31.

If the reliability (φ(n)_{fig}) of the tracking input information is low and the reliability (φ(n)_{func}) of the tracking function processing is medium, the reliability of the tracking information may be medium-low, and the corresponding score, according to table 51 of FIG. 5 and the above-mentioned Equation 1, may be 51 to 20.

If the reliability (φ(n)_{fig}) of the tracking input information is high and the reliability (φ(n)_{func}) of the tracking function processing is low, the reliability of the tracking information may be medium, and the corresponding score, according to table 51 of FIG. 5 and the above-mentioned Equation 1, may be 68 to 30.

If the reliability (φ(n)_{fig}) of the tracking input information is medium and the reliability (φ(n)_{func}) of the tracking function processing is low, the reliability of the tracking information may be medium-low, and the corresponding score, according to table 51 of FIG. 5 and the above-mentioned Equation 1, may be 48 to 10.

If the reliability (φ(n)_{fig}) of the tracking input information is low and the reliability (φ(n)_{func}) of the tracking function processing is low, the reliability of the tracking information may be low, and the corresponding score, according to table 51 of FIG. 5 and the above-mentioned Equation 1, may be 30 to 0.

When the reliability score of the tracking reliability determined according to the above-described scheme is equal to or greater than the first reference tracking reliability score (i.e., 70 points), the system 100 for determining reliability may be configured to determine the corresponding LiDAR track as a reliable track and output related information.

Furthermore, when the reliability score of the tracking reliability determined according to the above-described scheme is equal to or less than the second reference tracking reliability score (i.e., 30 points), the system 100 for determining reliability may be configured to determine the corresponding LiDAR track as an unreliable track and output related information.

Furthermore, when the reliability score of the tracking reliability determined according to the above-described scheme is less than the first reference tracking reliability score and exceeds the second reference tracking reliability score, information indicating that the corresponding LiDAR track is a track that does not correspond to the above two matters may be output.

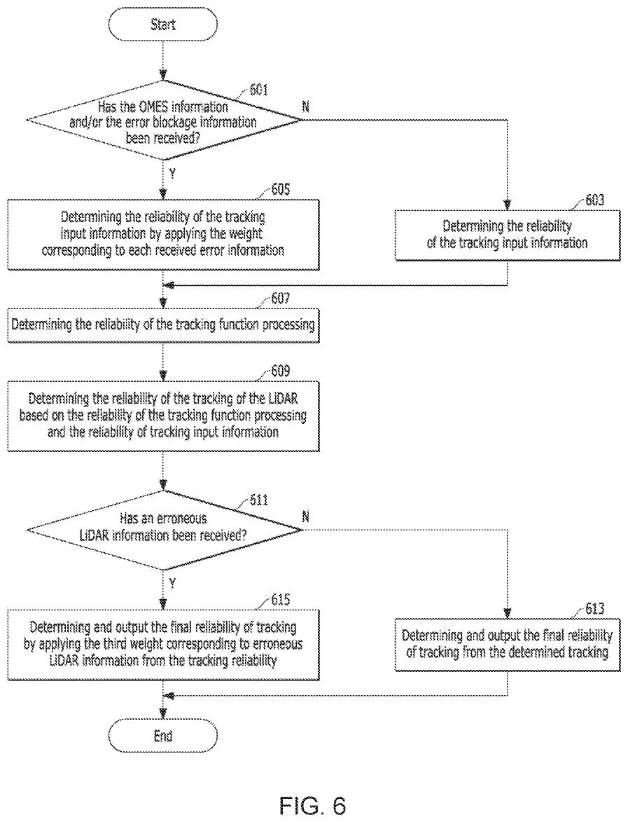

FIG. 6 is a flowchart of an operation of the system for determining reliability 100 (and/or the processor 130) according to an exemplary embodiment of the present disclosure.

Referring to FIG. 6, the system for determining reliability 100 may be configured to determine whether to receive OMES (online misalignment estimation) error information and/or blockage error information of the LIDAR 151 due to dust or the like from the sensor device 150 in operation 601.

The system 100 for determining 100 may perform operation 605 when receiving OMES error information and/or blockage error information of the LiDAR 151 due to the like of dust, and may otherwise perform operation 603.

The system 100 for determining reliability may be configured to determine the reliability of the tracking input information (603).

The system 100 for determining reliability may be configured to determine the reliability of the tracking input information through operations such as the exemplary embodiment of FIG. 2 and FIG. 3 described above.

The system 100 for determining reliability may be configured to determine the reliability of the tracking input information by applying a weight corresponding to each of the received error information (605).

The system 100 for determining reliability may be configured to perform the operations described with reference to FIG. 2 and FIG. 3. The reliability of the tracking input information determined through the operations may finally be determined by applying a weight corresponding to each of the received error information to the reliability of the tracking input information.

A first weight corresponding to the OMES error information may be previously designated, and a second weight corresponding to the disturb error information may be predetermined.

Accordingly, when the OMES error information and the disturbance error information are received, the system 100 for determining reliability may be configured to determine the reliability of the tracking input information by applying the sum of the first weight and the second weight to the reliability of the tracking input information determined through the above-described operations of the exemplary embodiments of FIG. 2 and FIG. 3.

Furthermore, when the OMES error information is received and the blockage error information is not received, the system 100 for determining reliability may apply the first weight to the reliability of the tracking input information determined through the above-described operations of the exemplary embodiments of FIG. 2 and FIG. 3 to finally determine the reliability of the tracking input information.

Furthermore, when the blockage error information is received without receiving the OMES error information, the system 100 for determining reliability may apply the second weight to the reliability of the tracking input information determined through the above-described operations of the exemplary embodiments of FIG. 2 and FIG. 3 to finally determine the reliability of the tracking input information.

The system 100 for determining reliability may be configured to determine the reliability of the tracking function processing (607).

The system 100 for determining reliability may be configured to determine the reliability of the tracking function processing through operations such as the exemplary embodiments of FIGS. 2 and 4 described above.

The system 100 for determining reliability may be configured to determine the tracking reliability of the LiDAR track based on the reliability of the tracking input information and the reliability of the tracking function processing (609).

The system 100 for determining reliability may be configured to determine the tracking reliability through operations such as the exemplary embodiment of FIGS. 2 and 5 described above.

The system 100 for determining reliability may be configured to determine whether error information of the LiDAR 151 (i.e., a left LiDAR and/or a right LiDAR) is received from the LIDAR 151 (611).

The system 100 for determining reliability may perform operation 615 when error information of the LiDAR 151 is received, and may perform operation 613 otherwise.

The system 100 for determining reliability may be configured to determine and output the tracking reliability determined according to operation 609 as the final tracking reliability (613).

The system 100 for determining reliability may be configured to determine and output a final tracking reliability by applying a third weight corresponding to the LIDAR error information to the tracking reliability determined according to operation 609 (615).

The third weight corresponding to the LiDAR error information may be predetermined.

The final tracking reliability may be a score included in a score of 0 or more to 100 or less.

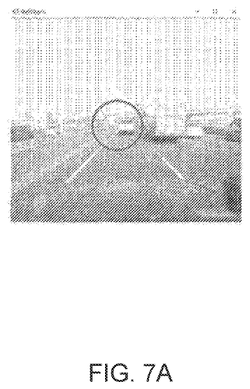

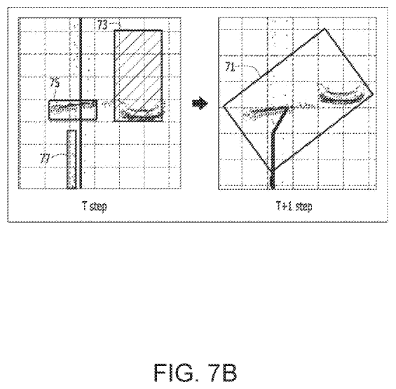

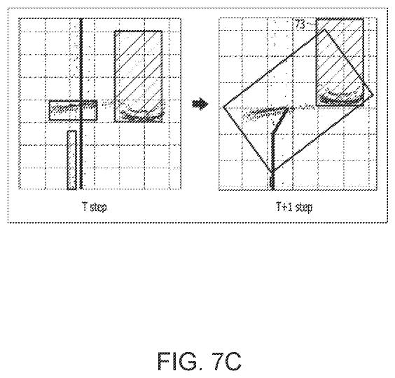

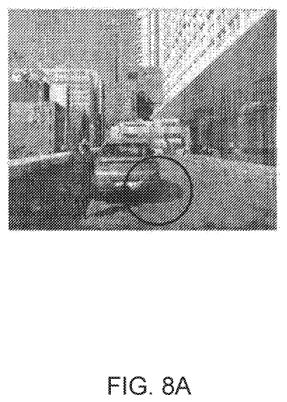

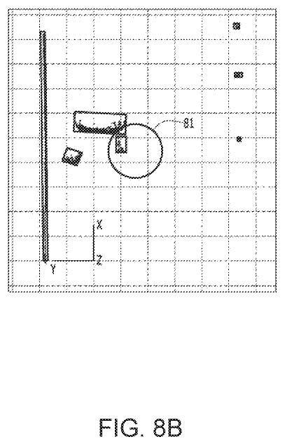

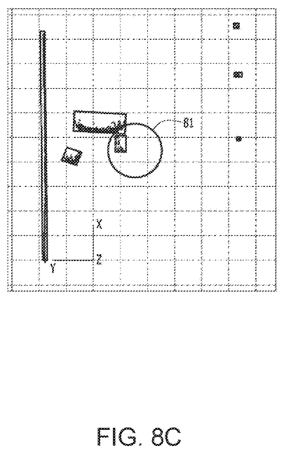

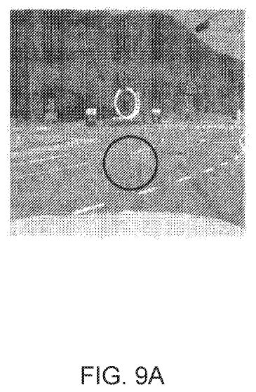

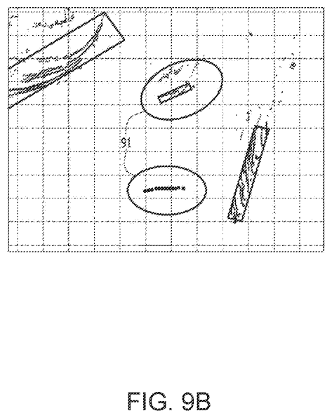

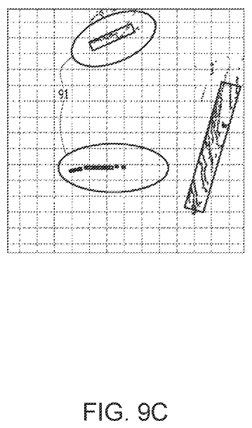

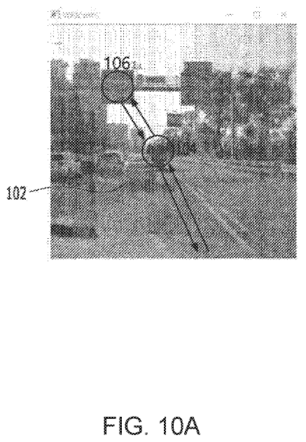

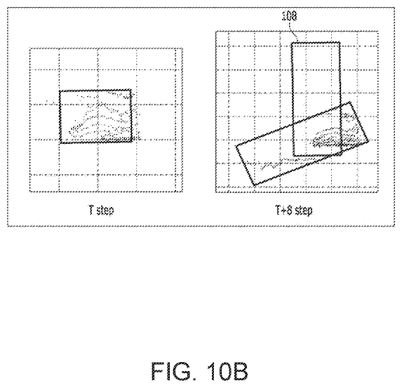

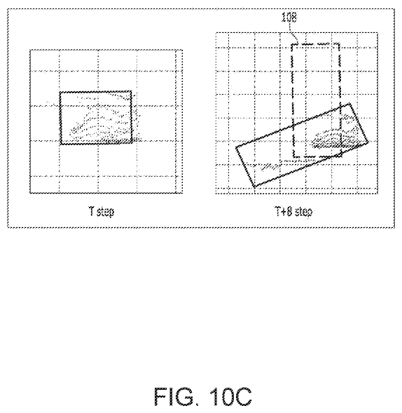

FIG. 7A. FIG. 7B and FIG. 7C. FIG. 8A, FIG. 8B and FIG. 8C, FIG. 9A. FIG. 9B and FIG. 9C and FIG. 10A, FIG. 10B and FIG. 10C are drawings for explaining an effect of an exemplary embodiment of the present disclosure

Referring to FIG. 7A, FIG. 7B and FIG. 7C, when the front vehicle and the guardrail are present in front of the vehicle 1 as illustrated in FIG. 7A, conventionally, as illustrated in FIG. 7B, tracks 73, 75, and 77 of each passenger are maintained in the T step, and the front vehicle and the guardrail are grouped into one group in the T+1 step and reduced to one track 71 in the related art. For example, there has been an issue where the track 703 corresponding to the preceding vehicle 73 does not appear in the T+1 step (T+1 step).

When an under-segmentation (also referred to as sensor value contamination) occurs in a Light Detection and Ranging (LiDAR) cluster, an identification (ID) of a stationary object is inherited and a moving object becomes private when tracking and linking the LiDAR track.

According to the above-described embodiments of the present disclosure, when the reliability is assigned to each LiDAR track of each object, even when under-segmentation (also referred to as sensor value contamination) occurs, the LiDAR track including high reliability is not allowed to disappear but maintained, solving the above-described conventional problem.

For example, in the determination of the reliability of the tracking function processing according to the above-described embodiment, when the weight of the score of the fourth reliability of the enabled processing for determining whether the object is the moving object or the stationary object is determined to be the highest among the first reliability to the fifth reliability, the corresponding LiDAR track of the front vehicle as the moving object has high reliability and the object detection system 10 may identify the present information. Accordingly, as shown in FIG. 7C, the object detection system 10 may solve the above-described longitudinal problem by maintaining the LIDAR track 73 of the preceding vehicle even in the T+1 step. For example, in accordance with the exemplary embodiments described above, the object detection system 10 may maintain a memory track when identifying information that a LiDAR track is a reliable track (or also referred to as a memory track).

Referring to FIG. 8A, FIG. 8B and FIG. 8C, when a front vehicle emits exhaustion gas as shown in FIG. 8A, a LIDAR track 81 indicating the actual gas emission is recognized as a track indicating a stationary object in the related art.

However, according to the above-described embodiment, even when the object detection system 10 does not accurately recognize that the object is gas such as gas emission or dust, reliability is determined for each object, and thus the corresponding track may not be used for object detection according to information indicating that reliability of the corresponding LiDAR track 81 is low as shown in FIG. 8B.

Referring to FIG. 9A, FIG. 9B and FIG. 9C, in the road environment of FIG. 9A, there has been an issue where a LiDAR track 91 on the ground is recognized as a stationary object positioned in front of the vehicle 1, as shown in FIG. 9A. This is due to the LiDAR point corresponding to the ground is not completely removed.

However, according to the above-described embodiment, as the reliability is determined for each object, the object detection system 10 may identify information indicating that the reliability of the LiDAR track 91 corresponding to the ground is low as shown in FIG. 9B, and may not use the LiDAR track 91 for object detection.

Referring to FIG. 10A, FIG. 10B and FIG. 10C in the related art as shown in FIG. 10A, there has been an issue where noise is generated on the left side of the target vehicle 104 in front of the front vehicle 102 of the vehicle 1, and thus the vehicle 1 erroneously recognizes the shape of the target vehicle 104, which is not the actual shape of the target vehicle 104 but is the shape of the target vehicle 104. This has been caused due to the beam of the LiDAR 151 of the vehicle 1 being refracted by the preceding vehicle 102, reflected to the signpost 106, refracted back to the preceding vehicle 102, and generating a virtual image next to the target vehicle 104.

According to the related art as illustrated in FIG. 10B, the LiDAR track of the preceding vehicle 102 may be generated and output in the T step, and as the above-described problem occurs, a shape including a virtual image of the target vehicle 104 is generated and output as the LiDAR track 108 in the T+8 step according to the occurrence of the above-described problem, causing an error in object recognition of the vehicle 1.

However, when the reliability is assigned to each target object according to the above-described embodiment, the object detection system 10 may not use the LiDAR track of the corresponding object for object detection whereas the object drastically changes in shape lowering its reliability.

For example, as shown in FIG. 10C, the LiDAR track of the preceding vehicle 102 may be output at the T step. Furthermore, according to the occurrence of an effect described above, the LiDAR track 108 including a shape including the virtual image of the target vehicle 104 is output in a T+8 step (T+8 step), and according to the above-described embodiment, information indicating that the reliability of the corresponding LiDAR track 108 is low is also provided, and thus the object detection system 10 may object the LiDAR track of the corresponding object

The above-described embodiments may be implemented in the form of a recording medium for storing instructions executable by a computer. The instructions may be stored in the form of a program code, and when executed by a processor, generating a program module to perform operations of the disclosed exemplary embodiments of the present disclosure. The recording medium may be implemented as a computer-readable recording medium.

The computer-readable recording medium includes all types of recording media in which computer-readable instructions are stored. For example, there may be a Read Only Memory (ROM), a Random Access Memory (RAM), a magnetic tape, a magnetic disk, a flash memory, an optical data storage device, etc.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of determining reliability of a Light Detection and Ranging (LiDAR) track, the method including:
determining, by a processor, reliability of tracking input information for tracking a target object of the LiDAR track based on reliability of each of predetermined features related to the LIDAR track;
determining, by the processor, reliability of function processing of a system, based on processing reliability of each of predetermined functions of the system for tracking the target object; and
determining, by the processor, the reliability of the LiDAR track, based on the reliability of the tracking input information and the reliability of the function processing, and outputting reliability information.

2. The method of claim 1, wherein the determining of the reliability of the tracking input information including:
receiving at least one of online misalignment estimation error information and blockage error information from a sensor device, wherein a predetermined weight corresponding to at least one error information is applied to the LiDAR track.

3. The method of claim 1, wherein the determining of the reliability of the LiDAR track includes:
determining a first weight for the reliability of the tracking input information and a second weight for the reliability of the function processing based on a predetermined weight corresponding to a range of reliability of each reference tracking input information and a range of reliability of each reference function processing; and
determining the reliability of the LIDAR track by summing up the reliability of tracking input information to which the first weight is applied and the reliability of function processing to which the second weight is applied.

4. The method of claim 1, wherein the reliability of the LiDAR track is determined by applying a predetermined weight corresponding to LiDAR error information when the LiDAR error information is received from a LiDAR.

5. The method of claim 1, wherein the predetermined features includes at least one of a number of points of the LiDAR track, position information of the LiDAR track, a number of contours generated based on the points, shape information of the LiDAR track, occlusion information of the LiDAR track, or viewing angle information of the LiDAR track.

6. The method of claim 5, wherein the reliability of each of the predetermined features related to the LiDAR track includes a reliability score corresponding to the number of points based on predetermined score information corresponding to each of a number of reference points.

7. The method of claim 5, wherein the position information includes first position information including a minimal X-axis coordinate value and a minimal Y-axis coordinate value of the LiDAR track and second position information including a minimal Z-axis coordinate value of the LiDAR track, and
wherein the reliability of each of the predetermined features related to the LiDAR track includes reliability scores corresponding to the minimal X-axis coordinate value and the minimal Y-axis coordinate value of the LiDAR track based on a predetermined score corresponding to each of reference X-axis coordinate information and reference Y-axis coordinate information and a reliability score corresponding to the minimal Z-axis coordinate value of the LiDAR track based on a predetermined score corresponding to reference Z-axis coordinate information.

8. The method of claim 5, wherein the reliability of each of the predetermined features related to the LiDAR track includes a reliability score corresponding to the number of contours generated based on the points based on a predetermined score corresponding to each reference number of contours.

9. The method of claim 5, wherein the reliability of each of the predetermined features associated with the LiDAR track includes a reliability score corresponding to the shape information of the LiDAR track based on a predetermined score corresponding to each L shape or shape other than the L shape.

10. The method of claim 5, wherein the reliability of each of the predetermined features related to the LIDAR track includes a reliability score corresponding to the viewing angle information and the occlusion information of the LiDAR track based on a predetermined score corresponding to whether the LiDAR track is located in a reference viewing angle range or not and a predetermined score corresponding to whether an occlusion occurs or not.

11. The method of claim 1, wherein the predetermined functions include at least one of a speed extraction function of the LiDAR track, a heading calculation function of the LiDAR track, a classification function of the LiDAR track, a function of determining whether the target object is a stationary object or a moving object, or a function of generating output information of the LiDAR track, and
wherein reliability of processing each of the predetermined functions includes a reliability score within a predetermined reliability score range corresponding to each of the predetermined functions.

12. A system for determining reliability of a Light Detection and Ranging (LiDAR) track, the system comprising:
an interface for receiving sensor data from a sensing device; and
a processor communicatively or electrically connected to the interface,
wherein the processor is configured to perform:
determining reliability of tracking input information for tracking a target object represented by the LiDAR track based on reliability of each of predetermined features related to the LiDAR track generated based on points obtained from a LIDAR of the sensing device;
determining reliability of function processing of the system based on processing reliability of each of predetermined functions of the system for tracking the target object; and
determining the reliability of the LiDAR track based on the reliability of the tracking input information and the reliability of the function processing to output reliability information.

13. The system of claim 12, wherein the reliability of the tracking input information including receiving at least one of online misalignment estimation error information and blockage error information from a sensor device, wherein a predetermined weight corresponding to at least one error information is applied to the LIDAR track.

14. The system of claim 12, wherein the processor is further configured to perform:
determining a first weight for the reliability of the tracking input information and a second weight for the reliability of the function processing based on the predetermined weight corresponding to a range of reliability of each reference tracking input information and a range of reliability of each reference function processing; and
determining the reliability of the LiDAR track by summing up the reliability of tracking input information to which the first weight is applied and the reliability of function processing to which the second weight is applied.

15. The system of claim 12, wherein the reliability of the LiDAR track is determined by applying a predetermined weight corresponding to LiDAR error information when the LIDAR error information is received from a LIDAR.

16. The system of claim 12, wherein the predetermined features includes at least one of a number of points of the LiDAR track, position information of the LiDAR track, a number of contours generated based on the points, shape information of the LiDAR track, occlusion information of the LiDAR track, or viewing angle information of the LIDAR track.

17. The system of claim 16, wherein the reliability of each of the predetermined features related to the LiDAR track includes a reliability score corresponding to the number of points based on predetermined score information corresponding to each of a number of reference points.

18. The system of claim 16, wherein the position information includes first position information including a minimal X-axis coordinate value and a minimal Y-axis coordinate value of the LiDAR track and second position information including a minimal Z-axis coordinate value of the LiDAR track, and
wherein the reliability of each of the predetermined features related to the LiDAR track includes reliability scores corresponding to the minimal X-axis coordinate value and the minimal Y-axis coordinate value of the LiDAR track based on a predetermined score corresponding to each of reference X-axis coordinate information and reference Y-axis coordinate information and a reliability score corresponding to the minimal Z-axis coordinate value of the LiDAR track based on a predetermined score corresponding to reference Z-axis coordinate information.

19. The system of claim 16, wherein the reliability of each of the predetermined features related to the LiDAR track includes at least one reliability score of a reliability score corresponding to the number of contours generated based on the points based on a predetermined score corresponding to each reference number of contours, a reliability score corresponding to the shape information of the LiDAR track based on a predetermined score corresponding to each L shape or shape other than the L shape, or a reliability score corresponding to the viewing angle information and the occlusion information of the LiDAR track based on a predetermined score corresponding to whether the LiDAR track is located in a reference viewing angle range or not and a predetermined score corresponding to whether an occlusion occurs or not.

20. The system of claim 12, wherein the predetermined functions include at least one of a speed extraction function of the LIDAR track, a heading calculation function of the LiDAR track, a classification function of the LIDAR track, a function of determining whether the target object is a stationary object or a moving object, or a function of generating output information of the LiDAR track, and
wherein reliability of processing each of the predetermined functions includes a reliability score within a predetermined reliability score range corresponding to each of the predetermined functions.
